(19) United States
(12) Patent Application Publication
(10) Pub. No.: US 2007/0044731 A1
(43) Pub. Date: Mar. 1, 2007

(54) Bird-friendly Sheet (flat) Glass (Klem-glass) and Sheet (flat) Plastic (Klem-plastic): panes with patterns that result in birds avoiding the space occupied by these windows and thereby preventing birds from being killed or injured by colliding with (striking) clear and tinted glass and plastic

(76) Inventor: Daniel Klem JR., Allentown, PA (US)

Correspondence Address: DANIEL KLEM, JR., 110 ASPEN DRIVE, ALLENTOWN, PA, 18104-9552, US

(21) Appl. No.: 11/162,008

(22) Filed: Aug. 25, 2005

(51) Int. Cl. A01K 37/00

(52) U.S. Cl. 119/712

(57) ABSTRACT

Through various means, a visible or invisible uniform pattern to the normal human eye is created in sheet (flat pane) glass or plastic. The patterns are visible to the normal avian eye but may or may not be visible to the normal human eye. The elements forming the pattern: (1) uniformly cover an entire pane (sheet) of flat glass or plastic, (2) are of any shape or size, and (3) are separated by 5 centimeters (2 inches) or less and arranged in horizontal rows, vertical columns, both horizontal rows and vertical columns, or any other parallel arrangement of elements with similar spacing and variously angled from either or both the horizontal row and vertical column orientation. The elements forming the pattern are visible to birds viewing clear or tinted sheet (flat pane) glass or plastic. The patterns create a visual warning about the glass hazard in the environment. Such patterned glass or plastic are for use in all human structures: commercial, residential, and any other designated function having any of its exterior surface composed of sheet (flat pane) glass or plastic that faces the surrounding outside environment. The installation of this sheet (flat pane) glass or plastic in new and existing human structures will save the lives of billions of birds worldwide, among them the rare, threatened and endangered species that fall under the protection of the national laws of sovereign nations and international treaties.

### DESCRIPTION

The sheet (flat pane) glass and plastic on which bird protection patterns are created is either inorganic glass prepared using float glass technology or any other means, and plastic sheets (flat pane) using any means of plastic technology. Inorganic glass sheets, plastic sheets, or a combination in laminated form producing the same visual effects will create effective bird protection from collisions.

Elements creating a protective pattern will be invisible to the normal human eye but will be visible to the avian eye if created using ultraviolet (UV) reflectance or absorption in the 315 nanometers to 380 nanometers wavelength range (UV-A), and 380 nanometers to less than (<) 400 nanometers.

Elements creating a protective pattern will be visible to the normal human eye and the avian eye when viewing the glass or plastic from inside and outside a human structure; or alternatively, elements creating a protective pattern will be visible to the normal human eye and the avian eye when viewing the glass or plastic from outside but not when viewing the glass or plastic from inside a human structure.

Technologies currently exist to create sheet (flat pane) glass and plastic with either of these visual effects for humans and birds. The following are known means to create protective patterns in sheet (flat pane) glass and plastic. Other means may also exist, and if so, they can be used to create the described avian protective patterns.

1. Coatings on any surface of a solid or laminated pane or panes that create a pattern by reflecting or absorbing UV in the avian visual range and that is visible in the glass or plastic when viewed from outside a human structure. These created patterns may or may not be visible to the normal human eye when viewing the glass or plastic from outside (exterior) a human structure, and these created patterns may not be visible to the normal human eye when viewing the glass or plastic from inside a human structure. Coatings are molecularly bonded or adhere by other means and are an integral part of the glass and plastic surface.

2. Translucent (frosted) elements used to create a pattern. Translucent (frosted) elements can be applied on any surface of a solid or laminated pane or panes if the glass or plastic are clear (transparent) and placed at see-through sites such as corridors or where corners meet in human structures; patterns at such sites are visible to normal human and avian eyes when viewing the glass or plastic from outside or inside a human structure. Translucent (frosted) elements used to create the pattern typically will be on the outside surface of tinted glass or plastic, or on any other surface such that the pattern is visible to normal human and avian eyes when viewing the glass from outside a human structure. Translucent (frosted) elements can be applied to glass or plastic surfaces by acid etching, etching by other means, sand blasting, ceramic frit technique involving temperatures in excess of 648.9 degrees Centigrade (1200 degrees Fahrenheit), or any other means.

3. A pattern visible to normal human and avian eyes when viewing glass or plastic from outside but not inside a human structure (type of one-way glass or plastic) can be created using coatings as a permanent integral part of the glass or plastic surface, external non-permanent films, and nanoparticle technology where nanoparticles creating the pattern are an integral part of the sheet (flat pane) glass or plastic. Non-permanent films crafted with the described bird-protecting patterns are available for use such as those manufactured by the 3M Company and used in advertising to create a visible pattern when viewing the glass surface from outside a structure (like buses); the pattern is not visible when viewing from inside a structure.

A novel pane showing an avian protection pattern that is visible to the normal human and avian eyes when viewing the glass from outside a human structure but not visible when viewing (looking out) from inside a human structure can be created using nanoparticles that are placed within the glass or plastic. The particles reflect visible light wavelengths that create an avian protection pattern when viewed from outside but not when viewed from the inside of a human structure.

Experiments testing the following specific designs have confirmed that birds can effectively detect and avoid visible patterns covering the entire glass or plastic surface created with: (1) 2.5 centimeters (1 inch) stripes placed 10 centimeters (4 inches) apart forming parallel vertical columns, (2) 2.5 centimeters (1 inch) stripes placed 5 centimeters (2 inches) apart forming parallel vertical columns, (3) 2.5 centimeters (1 inch) stripes placed 5 centimeters (2 inches) apart forming parallel horizontal rows, (4) 2.5 centimeters (1 inch) stripes placed 8 centimeters (3 inches) by 10 centimeters (4 inches) apart in parallel horizontal rows and vertical columns forming a mesh (checkerboard or lattice) pattern where the 8 centimeter (3 inches) distance is between horizontal rows and the 10 centimeter (4 inches) distance is between vertical columns, and (5) 2.5 centimeters (1 inch) stripes placed 5 centimeters (2 inches) apart in parallel vertical columns and horizontal rows forming a mesh (checkerboard or lattice) pattern. The size (thickness of stripes, diameter of circles, dimensions of other shapes) of the elements making up the pattern may be increased or decreased and the spacing between elements making up the pattern may be increased or decreased but be no greater than 10 centimeters (4 inches) between a vertical column or 5 centimeters (2 inches) between a horizontal row to effect similar protection for birds. These same patterns will provide similar protection for birds and be invisible to the normal human eye if created with UV reflectance or absorption.

### BACKGROUND OF THE INVENTION

### Fields of Invention

glass manufacturing; plastic manufacturing; glass coatings; plastic coatings; glass etching; plastic etching; ceramic frit; architecture; building development; landscaping; animal control, protection and welfare; conservation biology; ornithology.

Clear and reflective flat pane (sheet) glass and plastic as windowpanes in all manner of human structures are passive killers of birds worldwide. Birds behave as if clear and reflective glass and plastic are invisible to them, and they kill or injure themselves colliding with windows. Billions of birds are killed worldwide after colliding with glass and plastic. This unintended avian mortality factor can be eliminated using the bird-friendly sheet (flat pane) glass (Klem-glass) and plastic (Klem-plastic) described here. Extensive observations and experiments reveal that all birds are potentially vulnerable to the glass and plastic hazard and fatal collisions are possible wherever birds and glass and plastic mutually occur. Bird kills at glass and plastic are substantial, foreseeable, and avoidable, and at least within the United States it is reasonable to expect that birds merit protection from glass and plastic collisions under the purview of the Migratory Bird Treaty Act of 1918 and the Endangered Species Act of 1973, and may merit equal or similar protection from glass and plastic under the purview of laws of other sovereign nations and international treaties.

### SUMMARY OF THE INVENTION

This invention describes a means by which clear and reflective sheet (flat pane) glass and plastic will be rendered visible to birds. Birds behave as if clear and reflective sheet (flat pane) glass and plastic are invisible to them, and they fly into (strike) the glass or plastic resulting in their death or injury. Billions of birds are killed worldwide at sheet (flat pane) glass and plastic of all sizes and in all types of human structures. These are unintended deaths that can be avoided if sheet (flat pane) glass and plastic are modified in a way that birds will recognize and avoid it as a barrier. Placing patterns on sheet (flat pane) glass and plastic composed of individual elements that uniformly cover and are separated by 2.5 centimeters (2 inches) or less is known to transform the space occupied by sheet (flat pane) glass and plastic into a barrier that birds will see and avoid. This invention will save the lives of billions of birds worldwide, and among them the rare, threatened and endangered species that fall under the protection of the national laws of sovereign nations and international treaties.

Through various means currently available to glass and plastic manufacturers and their allied product industries, a visible or invisible uniform pattern to the normal human eye can be created in flat pane (sheet) glass and plastic. If visible to the normal human eye the pattern is composed of elements that appear opaque or translucent and contrast with adjacent clear or reflective glass or plastic areas. The elements forming the pattern: (1) uniformly cover an entire pane (sheet), (2) are of any shape and size, and (3) are separated by 5 centimeters (2 inches) or less. Birds act as if the elements forming the pattern are visible to them when viewing the exterior (from the environment looking at the outside) surface of clear and tinted sheet (flat pane) glass and plastic. This patterned glass and plastic are intended and for use in all human structures: commercial, residential, and any other designated functions containing sheet (flat pane) glass or plastic that face the outside environment. The patterns create a visual warning about the hazard of glass and plastic to birds in the environment. Wild birds avoid flying into (striking) these uniquely patterned-type glasses and plastics by behaving as if they recognize the space the glass occupies as a barrier to be avoided. For all means by which these patterns are created on any surface of single or a multiple-pane unit, the patterns are visible to birds and may or may not be visible to the normal human eye when looking at the exterior surface of the glass or plastic from the environment outside a human structure. Depending on the means by which the patterns are created, the patterns may or may not be visible to the normal human eye looking at (through) the glass or plastic from inside a human structure.

### REFERENCES

American Ornithologists' Union. 1975. Report of the ad hoc committee on scientificeducational use of wild birds Auk 92 (Suppl.): 1A-27A.
Banks, R. C. 1979. Human related mortality of birds in the United States. U.S. Fishand Wildlife Service Special Report 215: 1-16.
Corcoran, L. M. 1999. Migratory Bird Treaty Act: strict criminal liability for non-hunting caused bird deaths. Denver University Law Review 77: 315-358.
Dunn, E. H. 1993. Bird mortality from striking residential windows in winter. J. Field Ornithology 64(3): 302-309.
Graham, D. L. 1997. Spider webs and windows as potentially important sources ofhummingbird mortality. J. Field Ornithology 68(1): 98-101.
Klem, D. Jr. 1989. Bird-window collisions. Wilson Bulletin 101(4): 606-620.
Klem, D. Jr. 1990. Bird injuries, cause of death, and recuperation from collisions with windows. J. Field Ornithology 61(1): 115-119.
Klem, D. Jr. 1990. Collisions between birds and windows: mortality and prevention. J. Field Ornithology 61(1): 120-128.
Klem, D. Jr. 1991. Glass and bird kills: an overview and suggested planning and design methods of preventing a fatal hazard. In Wildlife Conservation in Metropolitan Environments NIUW Symposium Series 2, L. W. Adams and D. L. Leedy, eds., National Institute for Urban Wildlife, MD, 99-104.
Klem, D. Jr., D. C. Keck, K. L. Marty, A. J. Miller Ball, E. E. Niciu, and C. T. Platt.2004. Effects of window angling, feeder placement, and scavengers on avianmortality at plate glass. Wilson Bulletin 116(1): 69-73.
O'Connell, T. J. 2001. Avian window strike mortality at a suburban office park. The Raven 72(2): 141-149.
Ogden, L. J. E. 1996. Collision course: the hazards of lighted structures and windows to migrating birds. World Wildlife Fund Canada and the Fatal Light Awareness Program.

What is claimed is:

1. A clear (transparent) or tinted (all colors) single (one) or multiple-pane unit (separated or laminated) of flat (sheet) inorganic glass or flat (sheet) inorganic plastic panes with a uniform pattern covering the entire pane and applied to one or more surfaces or created as an integral part of (within) the inorganic composition, where the pattern is composed of elements that appear visible (translucent [frosted], partially opaque, opaque) to the normal human eye when viewed from both the external (outside) and internal (inside) environment of a structure; the size (length, width, diameter, or other dimensions of irregular form) of the elements making up the pattern is 0.317 centimeter (0.125 inch) or greater and the spacing between elements is 0.317 centimeter (0.125 inch) to 10 centimeters (4 inches) if pattern elements are arranged in vertical columns or 5 centimeters (2 inches) if pattern elements are arranged in horizontal rows.

2. A clear (transparent) or tinted (all colors) single (one) or multiple-pane unit (separated or laminated) of flat (sheet) inorganic glass or flat (sheet) inorganic plastic panes with a uniform pattern covering the entire pane and applied to one or more surfaces or created as an integral part of (within) the inorganic composition, where the pattern is composed of elements that appear visible (translucent [frosted], partially opaque, opaque) to the normal human eye when viewed from the external (outside) environment and invisible when viewed from the internal (inside) environment of a structure; the size (length, width, diameter, or other dimensions of irregular form) of the elements making up the pattern is 0.317 centimeter (0.125 inch) or greater and the spacing between elements is 0.317 centimeter (0.125 inch) to 10 centimeters (4 inches) if pattern elements are arranged in vertical columns or 5 centimeters (2 inches) if pattern elements are arranged in horizontal rows.

3. A clear (transparent) or tinted (all colors) single (one) or multiple-pane unit (separated or laminated) of flat (sheet) inorganic glass or flat (sheet) inorganic plastic panes with a uniform pattern covering the entire pane and applied to one or more surfaces or created as an integral part of (within) the inorganic composition, where the pattern is composed of elements that appear invisible to the normal human eye when viewed from both the external (outside) and internal (inside) environment of a structure; the size (length, width, diameter, or other dimensions of irregular form) of the elements making up the pattern is 0.317 centimeter (0.125 inch) or greater and the spacing between elements is 0.317 centimeter (0.125 inch) to 5 centimeters (2 inches) if pattern elements are arranged in vertical columns or horizontal rows.

4. A pane or multiple-pane unit according to claims 1 or 2, where the elements of the pattern are translucent (frosted) and created by acid etching, ceramic frit technique, sand blasting, permanent surface coatings, non-permanent surface films, or any other technology.

5. A pane or multiple-pane unit according to claims 1 or 2, where the elements of the pattern are partially opaque or opaque and created by surface alterations or by substances placed on (permanent surface coatings or non-permanent surface films) or within (internal) the inorganic composition that reflect wavelengths visible to the normal human eye between approximately 400 nanometers and 750 nanometers.

6. A pane or multiple-pane unit according to claim 2, where the visible translucent (frosted), partially opaque or opaque elements of the pattern are created by nanoparticles that are an integral (internal, within) part of the inorganic composition and reflect (forming light interference zones) wavelengths between 400 nanometers and 750 nanometers that are visible to the normal human eye when viewed from one side (to face the external outside environment), that is, looking at the pane from outside the structure, but not visible (invisible) to the normal human eye when viewed from the other side (to face the internal inside environment), that is, looking through the pane from inside a structure to the outside.

7. A pane or multiple-pane unit according to claim 3, where the elements of the pattern are invisible to the normal human eye and are created by substances placed on (permanent surface coatings or non-permanent surface films) or within (internal) the inorganic composition that absorb or reflect ultraviolet (UV) wavelengths between: (1) 315 nanometers to 380 nanometers, or (2) 380 nanometers to less than 400 nanometers, or (3) 315 nanometers to less than 400 nanometers.

8. According to claims 1 or 2, a specific visible pattern resulting in birds being able to recognize a pane or multiple pane unit as a barrier to avoid consists of elements composed of parallel 2.5 centimeters (1 inch) stripes placed horizontally and vertically forming a checkerboard (lattice) pattern where the spacing between the parallel elements, element edge to element edge, form a mesh with openings 8 centimeters (3 inches) by 10 centimeters (4 inches) with the wider spacing of 10 centimeters (4 inches) occurring between the vertical column elements.

9. According to claims 1 or 2, a specific visible pattern resulting in birds being able to recognize a pane or multiple pane unit as a barrier to avoid consists of elements composed of parallel 2.5 centimeters (1 inch) stripes placed horizontally and vertically forming a checkerboard (lattice) pattern where the spacing between the vertical parallel elements is 10 centimeters (4 inches), element edge to element edge , and the spacing between the horizontal parallel elements is 5 centimeters (2 inches), element edge to element edge.

10. According to claims 1 or 2, a specific visible pattern resulting in birds being able to recognize a pane or multiple pane unit as a barrier to avoid consists of elements composed of parallel 2.5 centimeters (1 inch) stripes placed horizontally and vertically forming a checkerboard (lattice) pattern where the spacing between the vertical parallel elements is 5 centimeters (2 inches), element edge to element edge, and the spacing between the horizontal parallel elements is 5 centimeters (2 inches), element edge to element edge.

11. According to claims 1 or 2, a specific visible pattern resulting in birds being able to recognize a pane or multiple pane unit as a barrier to avoid consists of elements composed of parallel 2.5 centimeters (1 inch) stripes placed in vertical columns where the spacing between the stripes is 10 centimeters (4 inches), element edge to element edge.

12. According to claims 1 or 2, a specific visible pattern resulting in birds being able to recognize a pane or multiple pane unit as a barrier to avoid consists of elements composed of parallel 2.5 centimeters (1 inch) stripes placed in horizontal rows where the spacing between the stripes is 5 centimeters (2 inches), element edge to element edge.

13. According to claim 3, a specific invisible pattern resulting in birds being able to recognize a pane or multiple pane unit as a barrier to avoid consists of elements composed of parallel 2.5 centimeters (1 inch) stripes placed horizontally and vertically forming a checkerboard (lattice) pattern where the spacing between the vertical and horizontal parallel elements is 5 centimeters (2 inches), element edge to element edge, and the spacing between the horizontal elements is 5 centimeters (2 inches), element edge to element edge.

14. According to claim 3, a specific invisible pattern resulting in birds being able to recognize a pane or multiple pane unit as a barrier to avoid consists of elements composed of parallel 2.5 centimeters (1 inch) stripes placed vertically where the spacing between the vertical column stripes is 5 centimeters (2 inches), element edge to element edge.

15. According to claim 3, a specific invisible pattern resulting in birds being able to recognize a pane or multiple pane unit as a barrier to avoid consists of elements composed of parallel 2.5 centimeters (1 inch) stripes placed horizontally where the spacing between the horizontal row stripes is 5 centimeters (2 inches), element edge to element edge.
